(19) United States
(12) Patent Application Publication
(10) Pub. No.: US 2014/0232759 A1
(43) Pub. Date: Aug. 21, 2014

(54) DISPLAY

(71) Applicants: Michael David Simmonds, Ashford (GB); Mohmed Salim Valera, Chatham (GB)

(72) Inventors: Michael David Simmonds, Ashford (GB); Mohmed Salim Valera, Chatham (GB)

(73) Assignee: BAE SYSTEMS PLC, London (GB)

(21) Appl. No.: 14/240,911

(22) PCT Filed: Aug. 24, 2012
(86) PCT No.: PCT/GB2012/052087

§ 371 Date: Feb. 25, 2014

(30) Foreign Application Priority Data
Aug. 26, 2011 (GB) 1114771.7

(51) Int. Cl. G09G 3/34; G09G 3/36

(52) U.S. Cl. CPC G09G 3/3406; G09G 3/36
USPC 345/690; 345/87

(57) ABSTRACT

In present invention provides a micro-display device having a source of illumination comprising an array of illuminating portions and an image generator arranged for receiving a signal comprising image data and comprising an array of image forming portions which may be selectively activated to project image-bearing light corresponding with the image data when illuminated by light from the source of illumination. A controller is also provided, arranged for receiving the image data and for selectively activating illuminating portions of the array of illuminating portions according to the image data and according to predetermined criteria relating to heat generation or power consumption by the micro-display device.

The present invention relates to a micro-display, which may be used for injecting image bearing light into a waveguide assembly of a head-up, head or helmet-mounted display. This invention can also be used with conventional optical displays and is not solely applicable to waveguide displays.

A micro-display is small, typically in the region of a few mm up to 50 mm in size. It is used predominantly to inject image bearing light into a waveguide assembly which serves to expand the input pupil and output the expanded exit pupil for convenient viewing by a person. Such micro displays are often used in head-up, or head or helmet-mounted displays. The small size (and weight) of the micro display is useful particularly if it has to be supported by the head of a viewer. The invention can also be used with conventional HUD and HMD optical displays that use digital projectors instead of cathode ray tubes.

A micro-display comprises an image generator such as a Liquid Crystal on Silicon (LCoS) device having an array of elements which can be selectively activated in response to image data so that, when illuminated, image bearing light is generated. Typically, the LCoS device is transmissive and light generated by a source of illumination may either pass through an activated element of the array or it may be absorbed if an element is not activated, so projecting an image that may be channelled through further optical elements for viewing. Alternatively, an LCoS device may operate as a reflective imaging device, absorbing or reflecting illuminating light according to whether respective elements of the LCoS array are activated.

According to a first aspect, the present invention provides a micro-display device comprising:

a source of illumination comprising an array of illuminating portions;

an image generator arranged for receiving a signal comprising image data and comprising an array of image forming portions which may be selectively activated to project image-bearing light corresponding with the image data when illuminated by light from the source of illumination; and

a controller arranged for receiving the image data and for selectively activating illuminating portions of the array of illuminating portions according to the image data and according to predetermined criteria relating to heat generation or power consumption by the micro-display device.

The controller may be arranged for activating only those illuminating portions of the array that are required for illuminating the activated image forming portions.

When an image is displayed over a small portion of an available display area, only a relatively small number of elements of the array are activated. This is often the case with head-up, or head or helmet-mounted displays since they are used predominantly to display information to a viewer in the form of symbology relating to a real world scene that the viewer observes through the display. A display for a pilot for example may display symbology such as altitude, bearing or information about objects moving relative to the aircraft. It will be appreciated that this type of symbology occupies only a small portion of the display area, perhaps as little as 5%. Since only a small portion of the elements of the array are activated, a large amount of the light emitted by the source of illumination in conventional displays is absorbed and the power supplied to the illumination source to generate the absorbed light is wasted. The generation of light by the illumination source causes heating of the source and the rest of the micro display. The display is compact and therefore has a relatively small surface area to volume ratio, which means that it does not dissipate heat well. Heating of the micro display can cause malfunctions. Additionally, it is undesirable to produce large amounts of heat if the micro display is situated close to a person's head as it could cause discomfort or injury.

The present invention enables illumination of an imaging device to be controlled in order to strike a balance between the level of heat output (and hence power consumption) by the display device, the nature of the images being generated at any one time, and the available contrast of images to be viewed against a background scene.

The illumination source control may be configured for selective control of the intensity of illumination emitted by each of the illuminating portions.

The illumination control may be configured to change the intensity of activated illuminating portions dependent on proportion of image forming portions activated in the image generator.

The illumination source may comprise a plurality of arrays of illuminating portions for generating illumination in respective sub-spectra of the visual spectrum for illuminating the activated image forming portions of the image generator with selectively controlled polychromatic illumination.

The array of the illumination source may comprise groups of illuminating portions, the illuminating portions in a group being configured to generate illumination in different sub-spectra of the visual spectrum for illuminating the activated image forming portions of the image generator with selectively controlled polychromatic illumination.

The image generator may an LCoS device and the image forming portions comprise liquid crystal elements.

The illumination source may comprise a micro LED device and the illuminating portions are micro LED elements.

According to a second aspect, the present invention provides a method for controlling heat generation or power consumption in operation of a micro-display device, the micro-display device comprising a source of illumination having an array of separately activable illuminating portions and an image generator having an array of image forming portions which can be selectively activated to project image bearing light when illuminated by light from the source of illumination, the method comprising selectively activating illuminating portions in the source of illumination to correspond with activated image forming portions in the image generator and controlling the intensity of light emitted by the selectively activated illuminating portions according to predetermined criteria relating to heat generation or power consumption.

Preferably, the method further comprises controlling the intensity of light emitted by the selectively activated illuminating portions according to brightness of a scene to be viewed in combination with an image generated by the micro-display device. The intensity of light emitted by the selectively activated illuminating portions may also be controlled according to the proportion of image forming portions being activated to form an image.

In order that the present invention may be well understood, embodiments thereof, which are given by way of example only, will now be described with reference to the accompanying drawings, in which:

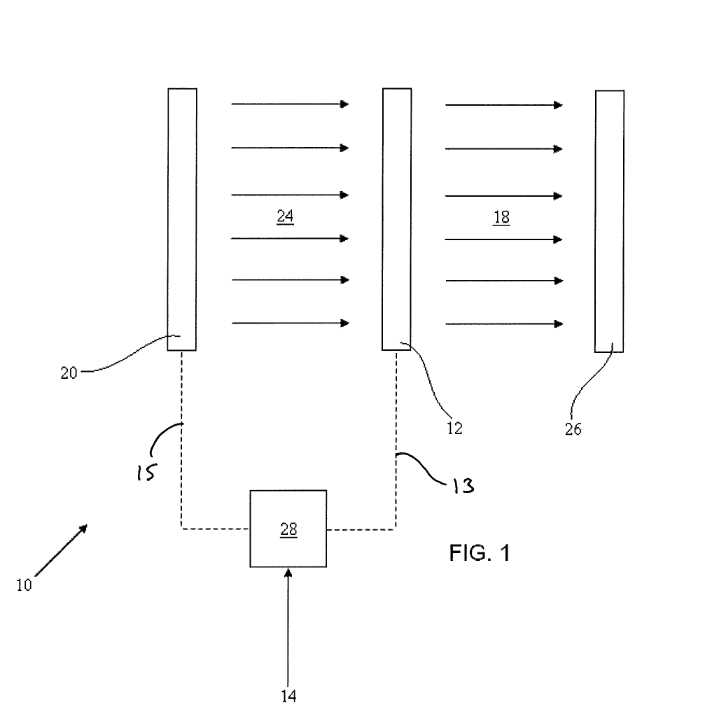

FIG. 1 shows schematically a micro display and waveguide assembly in a preferred embodiment of the present invention;

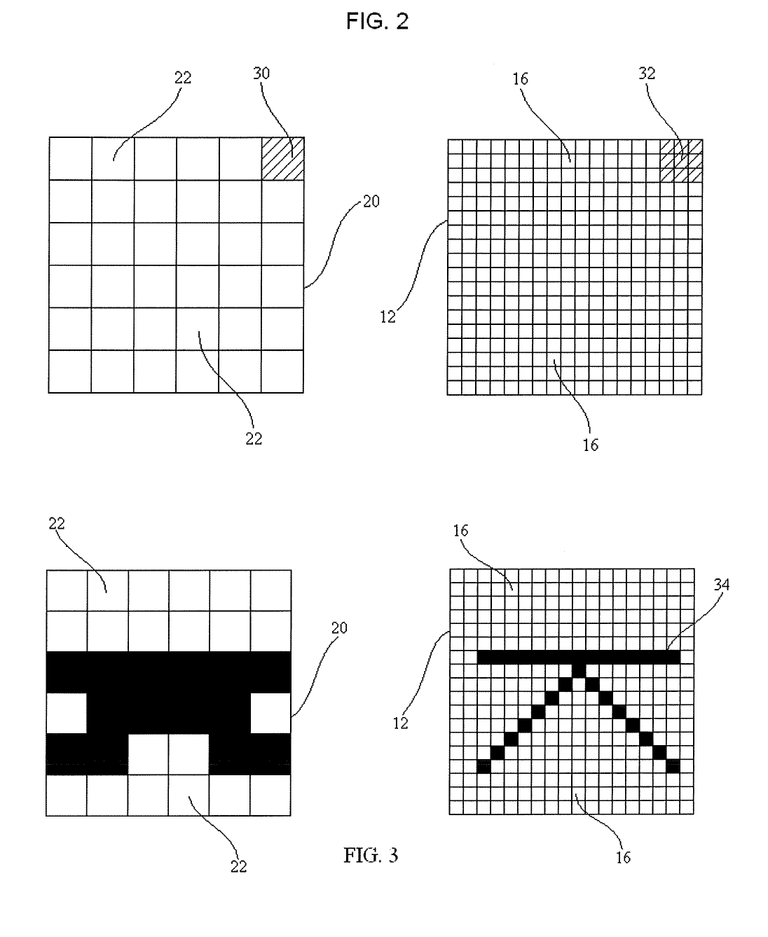

FIG. 2 shows an array of elements of an image generator of the micro display and an array of light sources in an associated illumination device;

FIG. 3 shows an image formed by the micro display in the embodiment of FIG. 2;

FIG. 4 shows an image formed by the micro display in another preferred embodiment;

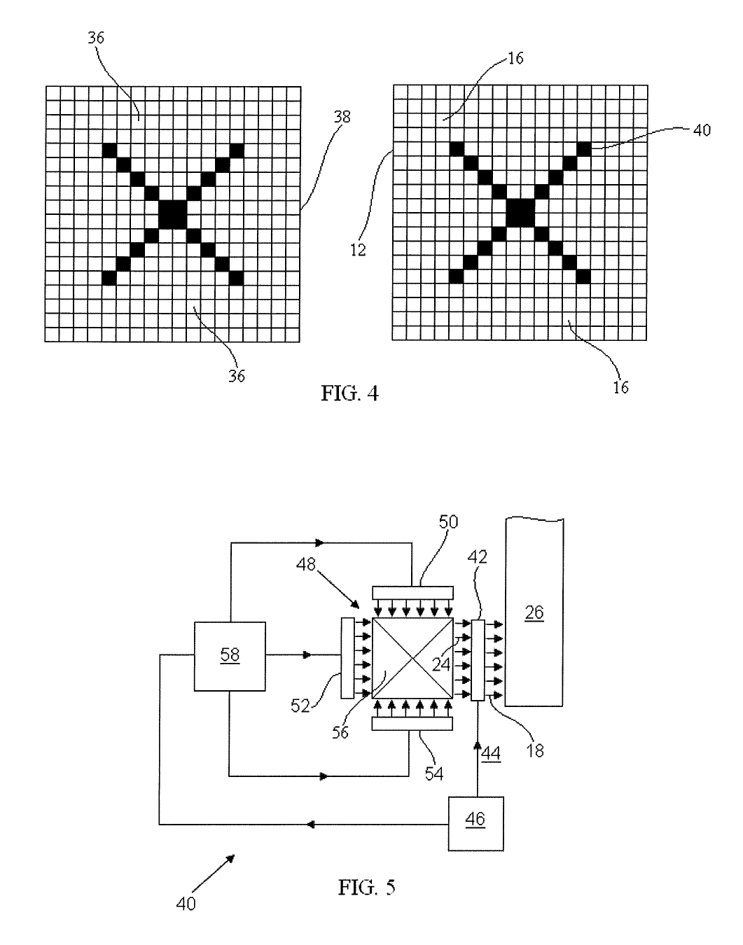

FIG. 5 shows a colour micro display in a further preferred embodiment of the present invention; and

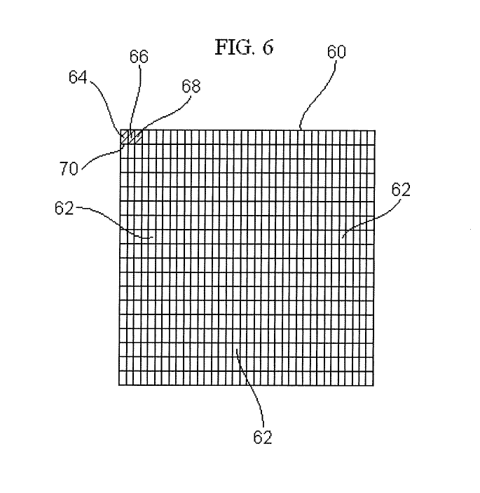

FIG. 6 shows a preferred source of illumination for a colour micro display.

Referring to FIGS. 1 and 2, there is shown a display device 10 for generating and displaying an image defined by data contained in a received signal 14. The display device 10 comprises an image generator 12 arranged for receiving a signal 13 comprising image data contained in the received signal 14. The image generator 12 comprises an array of image forming portions 16 which can be selectively activated as defined in the received image data 13 to generate image bearing light 18 when illuminated by a source of illumination 20. The image generator 12 may be a Liquid Crystal on Silicon (LCoS) micro display in which the image forming portions 16 are liquid crystal elements arranged selectively to block or allow the passage of illuminating light from the source 20. Alternatively, the image generator 12 may be a reflective device arranged selectively to reflect or to absorb incident illuminating light (20).

The source of illumination 20 is arranged for receiving a control signal 15 and comprises an array of illuminating portions 22 which can be selectively activated according to the content of the control signal 15. For example, the control signal 15 may cause the source 20 to generate illumination 24 for illuminating only those regions of the image generator 12 comprising activated image forming elements 16. The resultant image bearing light 18 is injected into a display device 26 such as a waveguide display for projecting an image to a viewer. The waveguide display 26 may for example be a head-up display, or a head or helmet-mounted display.

A controller 28 is arranged to receive the signal 14 and to output the signal 13 for controlling the image generator 12 and the signal 15 for controlling the generation of light by the source of illumination 20, according to the image data content of the received signal 14. A single controller 28 may be provided as shown in FIG. 1 or separate controllers may be provided, each arranged to receive the signal 14 and to generate the signals 13 and 15 for controlling the image generator 12 and the illumination source 20 respectively. The controllers may be formed as part of the illumination source 20 or the image generator 12. As shown, the controller 28 processes the received signal 14 and in order to produce a required image activates selected image forming portions 16 and illuminating portions 22.

As shown in FIG. 2, the illuminating portions 22 correspond to one or more image forming portions so that light emitted by an illuminating portion illuminates only those corresponding image forming portions. For example, light emitted from illuminating portion 30 shown by hatching in FIG. 2 illuminates only the corresponding image forming portions 32 also shown by hatching. Accordingly, if the image data relates to an image in which only illuminating portions in the region 32 require illumination only illuminating portion 30 need be activated. The remainder of the illuminating portions 22 can be maintained in a deactivated state thereby conserving energy and generating less heat.

An example of an image 34 generated by the image generator 12 is shown in FIG. 3. The image generating portions 16 which form the image 34 and are required to be illuminated are shaded in the Figure. In order to illuminate those selected (shaded) image forming portions, the illuminating portions 22 which are shaded must be activated.

It will be appreciated from FIG. 3 that some of the light emitted by the activated illuminating portions is received by image forming portions which are not required to generate the image 34. This light is wasted. Nonetheless, the arrangement shown in FIG. 3 still constitutes an improvement over known micro displays in which the source of illumination is, as a whole, either off or on and therefore significantly more light is wasted, heat is generated and power is consumed.

In another arrangement shown in FIG. 4, the illuminating portions 36 of a modified source of illumination 38 correspond with respective image forming portions 16 of the image generator 12. That is, the source of illumination is arranged so that a single illuminating portion 36 illuminates a single and corresponding image forming portion 16 and there are the same number of illuminating portions as image forming portions. Accordingly, the image 40 can be generated by the image generator 12 without wasting light emitted by the source of illumination 38.

The present micro display device may be operated in such a manner as to reduce wastage of light and power, and improve display efficiency. In particular, the controller 28 may be arranged to operate the display device 10 according to a predetermined mean power or heat generation budget taking account of the content of the images to be displayed and the needs of a user in viewing the image against background scenes of varying brightness. In this regard, each of the image forming portions 16 may be illuminated by light of the same intensity, or brightness, or selected illuminating portions 36 may be over-driven so that they emit light with greater intensity and the images projected by the display are brighter. With known displays, increasing the power provided to a light-emitting diode (LED) light source would lead to unacceptable overheating. Conversely, in typical applications of the present display device 10, only a relatively small proportion of the total number of illuminating portions 36 are driven at any one time, even if each selected illuminating portion 36 is over-driven the illumination source 38 overall generates no more and preferably less heat than in known displays.

If it is known in advance, from the image data contained in the received signal 14, that a display will be used to project images which occupy only a small proportion of the display, then the power at which particular illuminating portions 36 are driven may be selected in the knowledge that the mean level of heat generation over a period of time will not exceed a predetermined threshold. Accordingly each of the illuminating portions may be driven with generally the same power during use.

In another arrangement, the controller 28 may be configured for selective control of the intensity of illumination emitted by each of the illuminating portions 36. For example, the controller 28 may be configured to change the intensity of activated illuminating portions 36 in dependence upon the proportion of image forming portions 16 activated in the image generator 12. Therefore, if only a small proportion of the image generator 12 is used for projecting symbology, the selected illuminating portions 36 required for illuminating the image forming portions may be over-driven. Such a situation is likely during day-time use of a helmet-mounted display by an aircraft pilot as the quantity of information needed to supplement the real-world scene may be less than during night-time use when less of the real-world scene is visible and greater reliance must be placed upon instrumentation and video images of the outside world. During daytime use, symbology and other flight data in the generated image would need to be brighter, to be visible against the daylight background, than for night-time use. Thus, an ability to control the intensity of illumination by the source—greater intensity for a smaller image content in daytime, lesser intensity over a greater image content, including video, for night-time use—while remaining within a predetermined heat generation budget is particularly advantageous in helmet-mounted displays. The heat generation budget may be dependent upon the mean rate of heat dissipation by heat management systems in the display device, or may be designed to avoid exceeding a peak surface temperature over any part of the display device. Such features are also of particular advantage in applications in which the supply of power is limited, as for example when used by roaming personnel carrying their own power source.

Another micro display 40 is shown in FIG. 5 for displaying in colour. The display comprises an image generator 42 arranged for receiving a signal 44 comprising image data. The signal is output from generator control 46 which may be an image processor. If for example the micro display is incorporated in a helmet mounted display for a pilot, the image processor 46 may receive data signals from an aircraft's flight control computer.

The image generator comprises an array of image forming portions 16, as described previously with respect to FIGS. 1 to 3, which can be selectively activated to generate image bearing light 18 corresponding with the image data when illuminated by a source of illumination 48. The source of illumination 48 is arranged for receiving the image data and emitting light 24 for illuminating the image generator in accordance with the image data. The image bearing light 18 is injected into a display device 26 such as a waveguide display for projecting an image to a viewer. The waveguide display may for example be a head-up display, or a head or helmet-mounted display.

In this embodiment, the source of illumination 48 comprises a plurality of arrays of illuminating portions for generating illumination in respective sub-spectra of the visual spectrum for illuminating the activated image forming portions of the image generator with selectively controlled polychromatic illumination. The individual sources of illumination may be respective micro LED devices, for emitting light of different primary colours for example red, green and blue. As shown, a red source 50 emits red light, a green source 52 emits green light and a blue source 54 emits blue light. Each of the individual sources comprises an array of illuminating portions which can be selectively activated according to the image data to generate illumination for illuminating only those regions of the image generator comprising activated image forming portions. The illuminating portions are similar to those already described with reference to FIGS. 1 to 3 and therefore need not be described again. Of course though, in this embodiment the illuminating portions of different individual sources illuminate different colour light and may be red, green and blue elements of respective micro LED devices. An optical splitter 56 conveys light form all of the individual sources to the image generator.

An illumination source controller 58 is arranged to receive image data from the image processor 46 in this embodiment and is operably connected to the individual sources 50, 52, 54 so that selected illuminating portions of the three individual sources can be activated to illuminate only those portions of the image generator which require illumination. For example, if a red image is required, selected red micro LEDs of the source 50 are activated. The light from two or more of the sources can also be combined for generating images in colours other than red, green and blue. For example, selected green micro LEDs and selected blue micro LEDs of respective sources 52, 54 can be activated for generating a cyan image.

By way of further example, the control 58 and the individual sources 50, 52, 54 may be arranged so that the intensity of light emitted from selected illuminating portions can be varied. In this way, full colour images can be achieved for example using the RGB colour model, by varying the intensity of light emitted from two or three of the individual sources.

In the FIG. 5 embodiment, three individual illumination sources comprise respective arrays of different colour illuminating portions. In an alternative shown in FIG. 6, a single source of illumination 60 may comprise an array of different colour illuminating portions 62. For example red 64, green 66 and blue 68 elements are grouped together at regions 70 so that elements of any selected colour can be activated at any selected region for emitting light of one of the primary colours or an additive combination of any of the colours. A single such region is shown hatched in FIG. 6 having different colour elements and this pattern is repeated across the whole array.

In common with the micro-display 10 described above, an illumination source controller 58 may be used not only to select regions 70 and individual illuminating portions 62 for activation, but also to control the intensity of light to be emitted from the selected regions 70 and/or by the selected portions 62 on similar bases to those for the embodiments described above. That is, image content, mean heat or available power budget, brightness of the real-world scene and the needs of a user may all be taken into account when selecting the illumination intensity for each illuminating portion 62.

Whereas the preferred embodiments of the present invention have been described above in the context of a micro-display device, the principles of selective illumination may be applied to projection display devices of a larger scale, considered to fall outside the scope of a “micro-display”, in which similar requirements exists to manage the levels of heat generated by illumination sources.

1. A micro-display device comprising:
a source of illumination comprising an array of illuminating portions;
an image generator arranged for receiving a signal comprising image data and comprising an array of image forming portions which are arranged to be selectively activated to project image-bearing light corresponding with the image data when illuminated by light from the source of illumination; and
a controller arranged for receiving the image data and for selectively activating illuminating portions of the array of illuminating portions according to the image data and according to predetermined criteria relating to heat generation or power consumption by the micro-display device.

2. The display device according to claim 1, wherein the controller is arranged to activate only the illuminating portions of the array that are required for illuminating the activated image forming portions.

3. The display device according to claim 1, wherein the controller is configured for selective control of the intensity of illumination by each of the illuminating portions.

4. The display device according to claim 3, wherein the controller is arranged to receive a signal indicative of the brightness of a background scene to be viewed in combination with an image generated by the display device and to control the intensity of illumination by each of the illuminating portions, additionally, to take account of said brightness.

5. The display device according to claim 3, wherein the controller is configured to change the intensity of activated illuminating portions in dependence upon the proportion of image forming portions activated in the image generator.

6. The display device according to claim 1, wherein the illumination source comprises a plurality of arrays of illuminating portions for generating illumination in respective sub-spectra of the visual spectrum for illuminating the activated image forming portions of the image generator with selectively controlled polychromatic illumination.

7. The display device according to claim 1, wherein the array of the illumination source comprises groups of said illuminating portions, the illuminating portions in a group being configured to generate illumination in different sub-spectra of the visual spectrum for illuminating the activated image forming portions of the image generator with selectively controlled polychromatic illumination.

8. The display device according to claim 1, wherein the image generator is a reflective LCoS and the image forming portions comprise liquid crystal elements.

9. The display device according to claim 1, wherein the illumination source comprises a micro-LED array and the illuminating portions are micro LED elements.

10. The display device according to claim 1, wherein the image generator is a transmissive LCD and the image forming portions comprise liquid crystal elements.

11. The display device according to claim 1, wherein the image generator is a Digital Micro-Mirror Device and the image forming portions comprise a plurality of reflective tilting mirrors.

12. (canceled)

13. A helmet-mounted display incorporating a micro-display device according to claim 1.

14. A method for controlling heat generation or power consumption in operation of a micro-display device, the micro-display device comprising a source of illumination having an array of separately activable illuminating portions and an image generator having an array of image forming portions which can be selectively activated to project image bearing light when illuminated by light from the source of illumination, the method comprising selectively activating illuminating portions in the source of illumination to correspond with activated image forming portions in the image generator and controlling the intensity of light emitted by the selectively activated illuminating portions according to predetermined criteria relating to heat generation or power consumption.

15. The method according to claim 14, further comprising controlling the intensity of light emitted by the selectively activated illuminating portions according to brightness of a scene to be viewed in combination with an image generated by the micro-display device.

16. The method according to claim 14, further comprising controlling the intensity of light emitted by the selectively activated illuminating portions according to the proportion of image forming portions being activated to form an image.
